(19) United States
(12) Patent Application Publication
(10) Pub. No.: US 2013/0124971 A1
(43) Pub. Date: May 16, 2013

(54) REAL TIME WEB SCRIPT REFRESH USING ASYNCHRONOUS POLLING WITHOUT FULL WEB PAGE RELOAD

(71) Applicants: Gordon Bockus, JR., Austin, TX (US); Michael A. Bockus, Austin, TX (US); Derek R. Brewer, Austin, TX (US); Robert D. Wilhelm, Cheyenne, WY (US)

(72) Inventors: Gordon Bockus, JR., Austin, TX (US); Michael A. Bockus, Austin, TX (US); Derek R. Brewer, Austin, TX (US); Robert D. Wilhelm, Cheyenne, WY (US)

(73) Assignee: INTERNATIONAL BUSINESS MACHINES CORPORATION, New York, NY (US)

(21) Appl. No.: 13/297,558

(22) Filed: Nov. 16, 2011

(51) Int. Cl. G06F 17/00; G06F 15/16

(52) U.S. Cl. 715/234

(57) ABSTRACT

Enabling the updating of Web pages already received at the Web client station with only the change data, without the need to completely refresh the received Web page by transmitting a Web page from a Web page source site to a requesting receiving display station, and monitoring whether the source Web page of transmitted Web page has been modified. Changes in the Web pages are recorded at the page source site. Polling id done at selected intervals, at said receiving display station, to determine whether said source site monitoring indicates, i.e. has recorded, that the Web page has been modified subsequent to transmitting. In response to a determination that the source Web page has been modified, the recorded data representing the modification is requested by said receiving station from said source site.

### TECHNICAL FIELD

The present invention relates to computer managed communication networks, such as the World Wide Web (Web), and particularly to updating of Web pages at client requesting Web Stations after the Web pages have been received at the client station.

### BACKGROUND OF THE INVENTION

The Web or Internet (used interchangeably herein) is the network of virtually all electronic communication for trade, financial, governmental and educational transactions, as well all personal electronic discourse.

The Internet or Web is a global network of a heterogeneous mix of computer technologies and operating systems. Objects are linked to other objects in the hierarchy through a variety of network server computers. These network servers are the key to network distribution, such as the distribution of Web pages and related documentation. In this connection, the term “documents” is used to describe data transmitted over the Web or other networks and is intended to include Web pages with displayable text, graphics and other images.

Web documents, i.e. pages, are conventionally implemented in HTML (XML) language, which is described in detail in the text entitled: Just Java, Peter van der Linden, published by Prentice Hall, particularly at Chapter 7, pp. 249-268, dealing with the handling of Web pages; and also in the text Mastering the Internet, G. H. Cady et al., published by Sybex Inc., Alameda, Calif., 1996, particularly at pp. 637-642, on HTML in the formation of Web pages.

In addition, aspects of this invention will involve Web browsers. A general and comprehensive description of browsers may be found in the above-mentioned Mastering the Internet text at pp. 291-313. More detailed browser descriptions may be found in the text: Internet: The Complete Reference, Millennium Edition, Margaret Levine Young, published Osborne/McGraw-Hill; 2nd edition (Jun. 6, 2002), Chapter 20, pp. 455-494, on the Microsoft Internet Explorer.

Web browsers generally use the common language, JavaScript for computer applications involving Web pages transmitted from their sources and received at the client side computer controlled display stations wherein users interface with the Web pages. Web browser programs involved in the present invention are responsive to the JavaScript code instructions embedded in the HTML forming the received Web pages. JavaScript is a conventional simple interpreted scripting language that enables Web page developers to embed simple Java-like programming instructions within the HTML text of Web pages. For further information with respect to the use of JavaScript within HTML text in Web pages, reference is made to the description in the text: Dynamic HTML in Action, Michele Petrovsky, published by Osborne/McGraw-Hill, Berkeley, Calif., 1998, particularly at pages 150-158 and 184-185. It is understood that many functions may be added to HTML coding supporting Web pages.

Developers of JavaScript for Web pages transmitted from Web page sources on the Web must continually upgrade most Web pages in order to make changes in what is offered to the users of the various Web pages. Such changes made in the JavaScript defining the Web page at the Web server side of the Web, i.e. the server supporting the Web source site from which Web pages are generated and transmitted. The present invention recognizes that it would be very advantageous to provide developers of Web pages who are making changes in a Web page to have changes in the code, e.g. to the JavaScript loaded into the browser supporting a previously transmitted Web page at a receiving display station without completely refreshing the Web page and, thus, losing the current status of the Web page.

### SUMMARY OF THE INVENTION

The present invention enables the updating of Web pages already received at the Web client station with only the change data without the need to completely refresh the received Web page. The invention provides a method that comprises transmitting a Web page from a Web page source site to a requesting receiving display station, and then monitoring, at said Web page source site, whether the source Web page of transmitted Web page has been modified. Changes in the Web pages are recorded at the page source site. Polling is done at selected intervals, at said receiving display stations, to determine whether said source site monitoring indicates that, i.e. the Web page has been modified, subsequent to the transmitting. In response to a determination that the source Web page has been modified, the recorded data representing the modification is requested by said receiving station from said source site. This change data is used to modify the transmitted Web page at said receiving display station without completely refreshing or renewing, i.e. transmitting a new Web page. Preferably, a Web browser at the receiving Web station conducts the polling, the requesting of data representative of the modification and, as described above, the changing of the Web page to include the modification are carried out in a Web browser at the receiving station.

The monitoring to determine whether transmitted Web pages have been changed is carried out in a Web page source site server, and a pollable record of modified Web pages transmitted from the source site is maintained at the Web page source site where this record may be polled by the browsers of Web stations that received the Web pages being modified.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a very generalized view of portions of a network, e.g. Web, showing Web browsers at receiving Web stations;

FIG. 2 is a block diagram of a data processing system including a central processing unit and network connections via a communications adapter that is capable of functioning as users' computer controlled display stations and as Web servers at the Web page source sites;

FIG. 3 is an illustrative flowchart describing the setting up of the process of the present invention for enabling the updating of Web pages already received at the Web client station with only the change data without the need to completely refresh the received Web page; and

FIG. 4 is a flowchart of an illustrative run of the process setup in FIG. 3.

### DETAILED DESCRIPTION OF THE PREFERRED EMBODIMENT

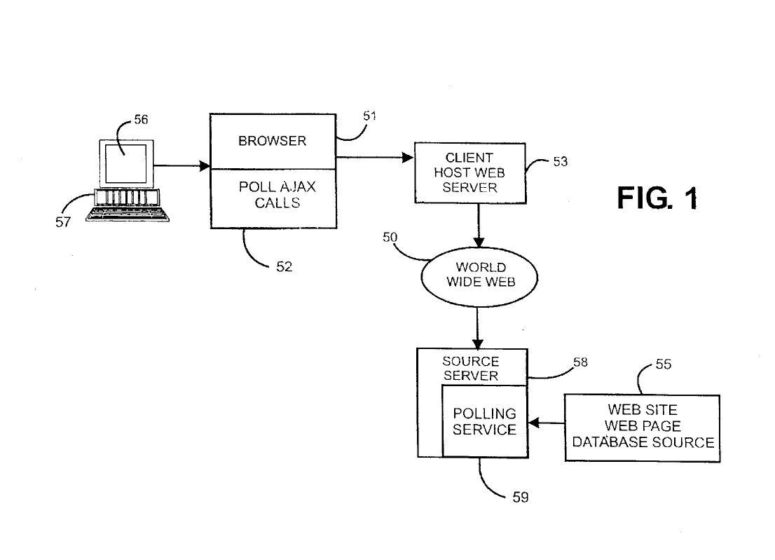

Referring to FIG. 1, there is shown a very generalized diagram of a Web portion on which the present invention may be implemented. The present invention may be implemented on any appropriate network for handling requests from a receiving network display station for information documents from other network sites requiring logon. Receiving client or user computer stations 57, having a user interactive display interface 56, controlled by a conventional Web browser program 51, such as the Microsoft® Internet Explorer® is typically connected to the Web 50 via standard Web wired connections through Web access server 53 that may be provided by a commercial service provider. Web pages are provided to a requesting station 57 from a source 55 on the Web that hosts the Web page including generating the page, storing versions of the Web page and updating the JavaScript that renders them as required by the host. The Web pages are provided from source 55 to Web 50 via Web server 58. Server 58 includes a polling service 59 that monitors and records changes in the JavaScript defining an already transmitted Web page in a sequential record that may be polled at regular intervals by a polling process 52 in browser 51. Polling process 52 polls service 59 seeking changes to a Web page that has had its AJAX (Asynchronous JavaScript and XML) code changed after the page has been received through the browser at station 57. Then, as will be set forth hereinafter in greater detail, the service interprets the change and updates the AJAX code defining the previously received Web page with only the code representing the change. This avoids the need to reload the whole new Web page that would result in the loss of the current state of the earlier received Web page.

The polling process 52 installed at station 57 under control of browser 51 is preferably deployed from server 58 in the same container as the earlier initial Web page and loaded at station 52 when this initial Web page was installed. The polling process polls the polling service 59 in server 58 to monitor when the Web page has been changed at its source 55. When the polling process 52 accesses the polling service 58, the current status of the monitored page file will be returned to browser 51 and the state of the page file will be updated.

For example code: JSON object

{

‘scripts/jsFile One.js’:false,
‘scripts/jsFile Two.js’:false,

}

when queried by the poll process 52 will return this JSON object to receiving station browser 51. After returning this data to browser 51, the state of monitored files will be set to false.

The polling process deployed to the browser 51 from server 58 should also include a configuration file that sets the polling interval for the client receiving station 57 and specifies which JavaScript files should be monitored. The following is a configuration file written in JSON code:

{
pollinginterval: 5, // poll the Web server on 5 second intervals
[

‘../scripts/jsFileOne.js’,
‘../scripts/jsFileTwo.js’,

]
}

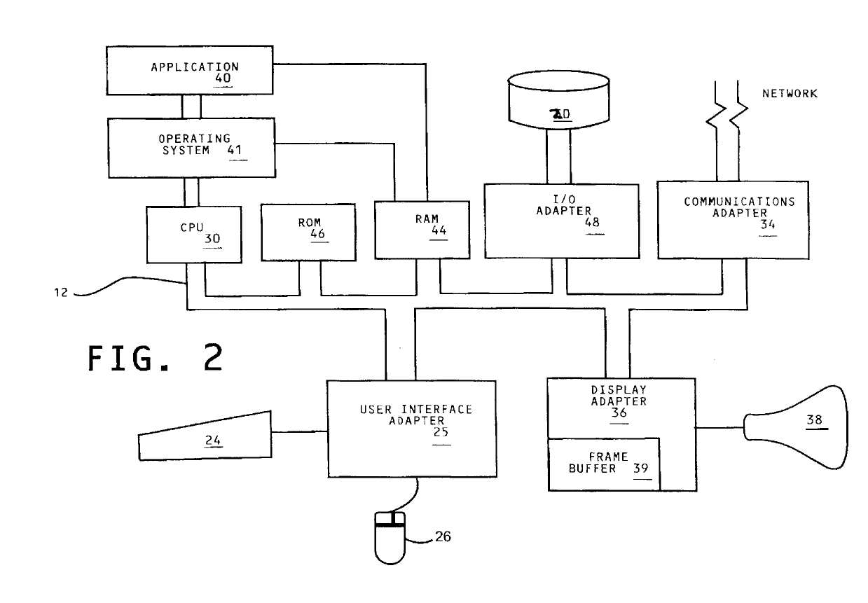

With respect to FIG. 2, there is shown an illustrative diagrammatic view of a data processing system including a central processing unit and network connections via a communications adapter that is capable of functioning as users' computer controlled display stations and as Web servers at the Web page source sites.

A central processing unit (CPU) 30, such as one of the microprocessors, e.g. from System p series available from International Business Machines Corporation (IBM), is provided and interconnected to various other components by system bus 12. An operating system 41 runs on CPU 30, provides control and is used to coordinate the function of the various components of FIG. 2. Operating system 41 may be one of the commercially available operating systems. Application programs 40, such as browser 51 and the polling process 52 (FIG. 1), in the client receiving station 51 controlled by its system or polling service 59 in the system of source server 58 are moved into and out of the main memory Random Access Memory (RAM) 44. These programming applications may be used to implement functions of the present invention. ROM 46 includes the Basic Input/Output System (BIOS) that controls the basic computer functions of Web station 57 or server 58. RAM 44, storage adapter 48 and communications adapter 34 are also interconnected to system bus 12. Storage adapter 48 communicates with the disk storage device 20. Communications adapter 34 interconnects bus 12 with the outside Web. I/O devices are also connected to system bus 12 via user interface adapter 25. Optionally, keyboard 24 and mouse 26 may be connected to bus 12 through user interface adapter 25. Where a display is used, display buffer 39 connected through display adapter 36 to bus 12 supports display 38.

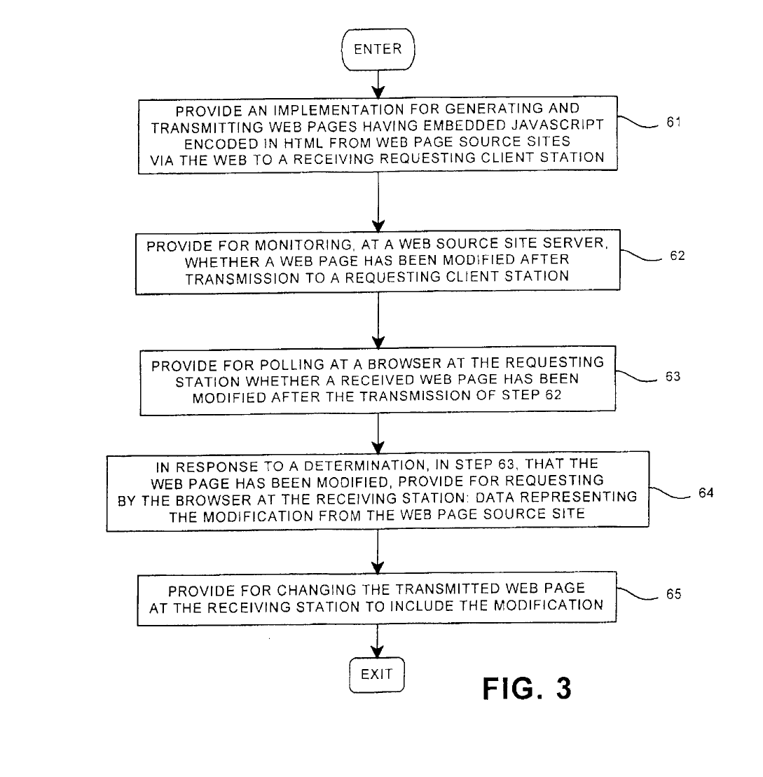

FIG. 3 is a general flowchart of an illustrative program set up to implement the present invention for enabling the updating of Web pages already received at the Web client station with only the change data without the need to completely refresh the received Web page.

There is provided an implementation for the generation of Web pages at Web page source sites that have JavaScript code embedded in the HTML (XML) code describing the Web page, and for transmitting such pages via the Web to receiving requesting Web stations, step 61. Provision is made for monitoring, at a Web source site server, whether a Web page has been modified after transmission of the Web page to a requesting Web station, step 62. Provision is made, step 63, for enabling the browser at the receiving Web station to poll the monitoring implementation at the source to determine whether an already received Web page has been modified after its receipt at the Web station. As described hereinabove, this polling process may conveniently be deployed from the Web page source server in the same container as the received initial Web page and loaded in the browser at the station when this initial Web page was installed.

In response to a determination in step 63 that the already received Web page has been modified, provision is made for requesting, by the polling browser from the Web page source, the data representative of the modification, step 64. At this point, provision is made for changing the Web page at the receiving station to update the JavaScript defining the Web page with the modification without reloading the whole modified Web page, step 65.

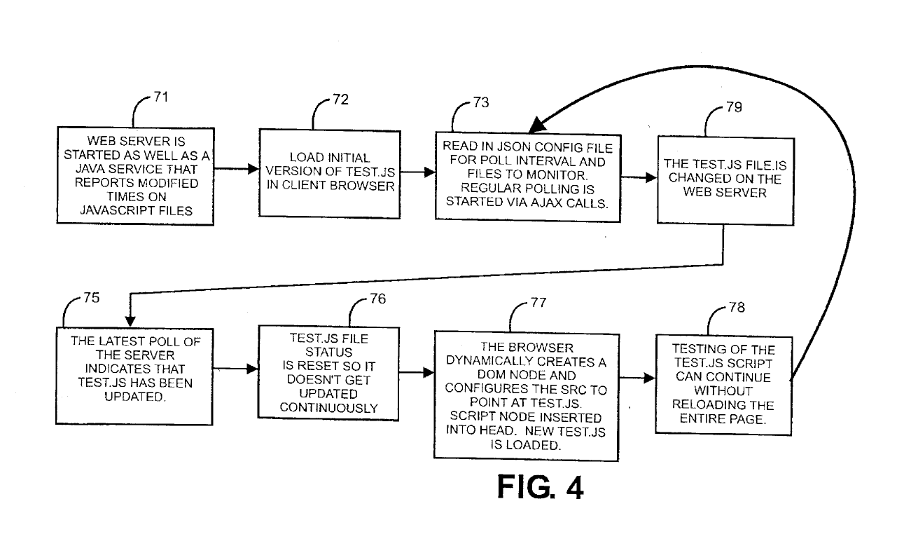

The running of the process set up in FIG. 3 will now be described with respect to the flowchart of FIG. 4. A web server at the Web page source site is started. In addition to its normal Web page deployment functions, there is loaded a Java polling service that reports the times of modification of the JavaScript data files for the deployed Web pages, step 71. At a receiving Web station, a browser is opened, and the browser loads a JavaScript file, an initial version of test.js is loaded in the browser, step 72. The JSON (JavaScript Object Notation) configuration file, transmitted from the Web source server is loaded via the Web station browser and provides the station with a configuration file defining poll intervals and Web page files to monitor after which polling is started via AJAX calls, step 73. When a test.js file is changed at the source Web server by the Web page developer that results in the modification time being altered, step 74, then the latest poll by the polling process at the Web station browser will indicate that test.js has been updated, step 75. At this point, the test.js file status is reset at the Web source server so that it no longer is seen as modified, step 76. Then the browser dynamically creates a DOM node that is a script take and configures the src attribute to point to test.js. The browser then inserts the script node into the head of the current document (page). The new test.js is loaded, step 77. The testing (polling) of this test.js script can continue without the need for any reload of the entire modified page, step 78, and the process is branched back to step 77 to continue the polling by the polling process via the browser.

As will be appreciated by one skilled in the art, aspects of the present invention may be embodied as a system, method or computer program product. Accordingly, aspects of the present invention may take the form of an entirely hardware embodiment, an entirely software embodiment, including firmware, resident software, micro-code, etc.; or an embodiment combining software and hardware aspects that may all generally be referred to herein as a “circuit”, “module” or “system.” Furthermore, aspects of the present invention may take the form of a computer program product embodied in one or more computer readable mediums having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared or semiconductor system, apparatus or device, or any suitable combination of the foregoing. More specific examples (a non-exhaustive list) of the computer readable storage medium would include the following: an electrical connection having one or more wires, a portable computer diskette, a hard disk, a Random Access Memory (“RAM”), a Read Only Memory (“ROM”), an Erasable Programmable Read Only Memory (“EPROM” or Flash memory), an optical fiber, a portable compact disc read only memory (“CD-ROM”), an optical storage device, a magnetic storage device or any suitable combination of the foregoing. In the context of this document, a computer readable storage medium may be any tangible medium that can contain or store a program for use by or in connection with an instruction execution system, apparatus or device.

A computer readable medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate or transport a program for use by or in connection with an instruction execution system, apparatus or device.

Program code embodied on a computer readable medium may be transmitted using any appropriate medium, including, but not limited to, wireless, wire line, optical fiber cable, RF, etc., or any suitable combination the foregoing.

Computer program code for carrying out operations for aspects of the present invention may be written in any combination of one or more programming languages, including an object oriented programming language, such as Java, Smalltalk, C++ and the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the later scenario, the remote computer may be connected to the user's computer through any type of network, including a local area network (“LAN”) or a wide area network (“WAN”), or the connection may be made to an external computer (for example, through the Internet, using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer or other programmable data processing apparatus to produce a machine, such that instructions, which execute via the processor of the computer or other programmable data processing apparatus, create means for implementing the functions/acts specified flowchart and/or block diagram block or blocks.

These computer program instructions may also be stored in a computer readable medium that can direct a computer, other programmable data processing apparatus or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagram in the Figures illustrate the architecture, functionality and operations of possible implementations of systems, methods and computer program products according to various embodiments of the present invention. In this regard, each block in the flowchart or block diagrams may represent a module segment, or portion of code, which comprises one or more executable instructions for implementing the specified logical function(s). It should be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustrations can be implemented by special purpose hardware-based systems that perform the specified functions or acts, or combinations of special purpose hardware and computer instructions.

Although certain preferred embodiments have been shown and described, it will be understood that many changes and modifications may be made therein without departing from the scope and intent of the appended claims.

What is claimed is:

1. In a World Wide Web communication network with user access to Web page source sites via data processor controlled interactive requesting display stations, a method for providing dynamically updated Web pages to a requesting display station comprising:
transmitting a Web page from a Web page source site to a requesting receiving display station;
monitoring, at said source site, whether the source Web page of the transmitted Web page has been modified;
polling at selected intervals, at said receiving display station, to determine whether said source site monitoring indicates the source page of said transmitted Web page has been modified subsequent to said transmitting;
responsive to a determination that said source page has been modified, requesting data representing the modification by said receiving station from said source site; and
changing said transmitted Web page at said receiving display station to include said modification.

2. The method of claim 1, wherein said Web page at said receiving display station is changed without a retransmission of the Web page.

3. The method of claim 1, wherein said polling, said requesting data representative of the modification and said changing of the Web page to include the modification are carried out in a Web browser at the receiving station.

4. The method of claim 3, wherein:
said received Web page is represented in JavaScript; and
said Web browser forms a Document Object Model including representing the Web page modification.

5. The method of claim 1, wherein said monitoring, at said source site, to determine whether the transmitted Web pages have been changed is carried out in a Web page source site server.

6. The method of claim 5, further including maintaining, at said Web page source site server, a pollable record of modified Web pages transmitted from the source site.

7. The method of claim 5, further including resetting said pollable record to indicate the absence of a modification after said data representative of a modification has been transmitted to said receiving station.

8. In a World Wide Web communication network with user access to Web page source sites via data processor controlled interactive requesting display stations, a system for providing dynamically updated Web pages to a requesting display station comprising:
a processor;
a computer memory holding computer program instructions that when executed by the processor perform the method comprising:
transmitting a Web page from a Web page source site to a requesting receiving display station;
monitoring, at said source site, whether the source Web page of the transmitted Web page has been modified;
polling at selected intervals, at said receiving display station, to determine whether said source site monitoring indicates the source page of said transmitted Web page has been modified subsequent to said transmitting;
responsive to a determination that said source page has been modified, requesting data representing the modification by said receiving station from said source site; and
changing said transmitted Web page at said receiving display station to include said modification.

9. The system of claim 8, wherein said Web page at said receiving display station is changed without a retransmission of the Web page.

10. The system of claim 8, wherein said polling, said requesting data representative of the modification and said changing of the Web page to include the modification are carried out in a Web browser at the receiving station.

11. The system of claim 10, wherein, in said performed method:
said received Web page is represented in JavaScript; and
said Web browser forms a Document Object Model including representing the Web page modification.

12. The system of claim 8, wherein, in said performed method, said monitoring, at said source site to determine whether the transmitted Web pages have been changed is carried out in a Web page source site server.

13. The system of claim 12, wherein said performed method further includes maintaining, at said Web page source site server, a pollable record of modified Web pages transmitted from the source site.

14. The method of claim 12, wherein said performed method further includes resetting said pollable record to indicate the absence of a modification after said data representative of a modification has been transmitted to said receiving station.

15. A computer usable storage medium having stored thereon a computer readable program for providing dynamically updated Web pages to a requesting display station in a World Wide Web communication network with user access to Web page source sites via data processor controlled interactive requesting display stations, wherein the computer readable program, when executed on a computer, causes the computer to:
transmit a Web page from a Web page source site to a requesting receiving display station;
monitor, at said source site, whether the source Web page of the transmitted Web page has been modified;
poll at selected intervals, at said receiving display station, to determine whether said source site monitoring indicates the source page of said transmitted Web page has been modified subsequent to said transmitting;
responsive to a determination that said source page has been modified, request data representing the modification by said receiving station from said source site; and
change said transmitted Web page at said receiving display station to include said modification.

16. The computer usable medium of claim 15, wherein said computer readable program when executed changes said Web page at said receiving display station without a retransmission of the Web page.

17. The computer usable medium of claim 15, wherein said computer readable program, when executed, carries out said computer polling, said requesting data representative of the modification and said changing of the Web page to include the modification in a Web browser program at the receiving station.

18. The computer usable medium of claim 17, wherein:
said received Web page is represented in JavaScript; and
said Web browser program, when executed, forms a Document Object Model including representing the Web page modification.

19. The computer usable storage medium of claim 15, wherein said computer readable program, when executed, monitors, at said source site, to determine whether the transmitted Web pages have been changed on a Web page source site server.

20. The computer usable medium of claim 19, wherein said computer readable program, when executed, further maintains, at said Web page source site server, a pollable record of modified Web pages transmitted from the source site.

21. The computer usable medium of claim 20, wherein the computer readable program further causes the computer to reset said pollable record to indicate the absence of a modification after said data representative of a modification has been transmitted to said receiving station.
